(19) United States
(12) Patent Application Publication
(10) Pub. No.: US 2025/0088417 A1
(43) Pub. Date: Mar. 13, 2025

(54) ARCHITECTURE FOR REMOTE DELIVERY AND APPLICATION OF DATACENTER MANAGEMENT CONFIGURATIONS

(71) Applicant: VMware, Inc., Palo Alto, CA (US)

(72) Inventors: Tomo Vladimirov Simeonov, Sofia (BG); Anil Narayanan Nair, Bengaluru (IN); Hakan Sunay Halil, Sofia (BG); Karolina Koleva, Sofia (BG)

(21) Appl. No.: 18/462,529

(22) Filed: Sep. 7, 2023

(51) Int. Cl. H04L 41/082; H04L 41/0273

(52) U.S. Cl. CPC H04L 41/082; H04L 41/028

(57) ABSTRACT

Various aspects are disclosed for remotely delivering, checking, and applying datacenter management configurations. A gateway service uses a set repository function provided that configures a datacenter management service to use a perimeter layer script repository of the gateway service for synchronization. The gateway service causes the datacenter management service to synchronize a datacenter layer script repository to store a script identified and retrieved from the perimeter layer script repository. The gateway service causes the datacenter management service to execute the script from its datacenter layer script repository.

### BACKGROUND

A datacenter management service can manage host devices of a datacenter. Since a datacenter management service can manage a large number of hosts, this service can be an important component in the overall datacenter architecture. While security and maintaining updated security and other configurations are important, downtime should be minimized. As a result, while installing or updating to a new version of a datacenter management service can be one option, the downtime involved with installing or updating can cause loss of productivity.

These issues can result in delays in the enterprise being informed of the security vulnerability and applying temporary and permanent fixes to keep the datacenter environment secure. As a result, there is a need for improvements in remote configuration status checks for datacenter management services, as well as remote delivery and application of datacenter level management configurations.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIG. 1 is a drawing of an example of a networked computing environment that includes a datacenter configuration management architecture.

FIG. 2 is a drawing that illustrates an example of the operation of the components of the datacenter configuration management architecture.

FIG. 3 is a sequence diagram illustrating functionalities implemented by components of the datacenter configuration management architecture.

FIG. 4 is a drawing that illustrates a user interface implemented by components of the datacenter configuration management architecture.

### DETAILED DESCRIPTION

The present disclosure relates to a unified architecture for remote status checks, delivery, and application of datacenter level management configurations. A datacenter management service can manage host devices of a datacenter. Since a datacenter management service can manage a large number of hosts, this service can be an important component in the overall datacenter architecture. While security and maintaining updated security and other configurations are important, downtime should be minimized. As a result, while installing or updating to a new version of a datacenter management service can be one option, the downtime involved with installing or updating can cause loss of productivity. Further, the period to produce and update to a new datacenter management service that does not have the security of configuration problem could be unacceptable due to the risk to the normal operations. Existing management services rely on knowledge-based approaches that require enterprise administrative users to read about security flaws and other datacenter management options, and manually reconfigure the environment to apply the configurations. Even if a script is available for download, there is no secure delivery pipeline. This can result in improper configurations and can open the door to accidental downloads from malicious websites offering similarly-named or addressed scripts. These issues can result in delays in the enterprise being informed of the security vulnerability and applying temporary and permanent fixes to keep the datacenter environment secure, particularly while remaining on the same version of the datacenter management service. As a result, there is a need for improvements in remote configuration status checks for datacenter management services, as well as remote delivery and application of datacenter level management configurations.

The present disclosure describes mechanisms that enable remote a security as a service option for enterprises that employ a datacenter management service. This can help maintain the security of the enterprise environments and improve many features and experiences in the datacenter environment. The remote delivery and application architecture can provide the end user the ability to identify current configurations of a management console of a datacenter management service. Execution of security scan scripts do not modify the operation or configuration of the datacenter management service. The remote delivery and application architecture can provide a pluggable infrastructure where additional intra-version scripts for the datacenter management service can be provided outside the normal life-cycle (e.g., updating versions) of datacenter management service.

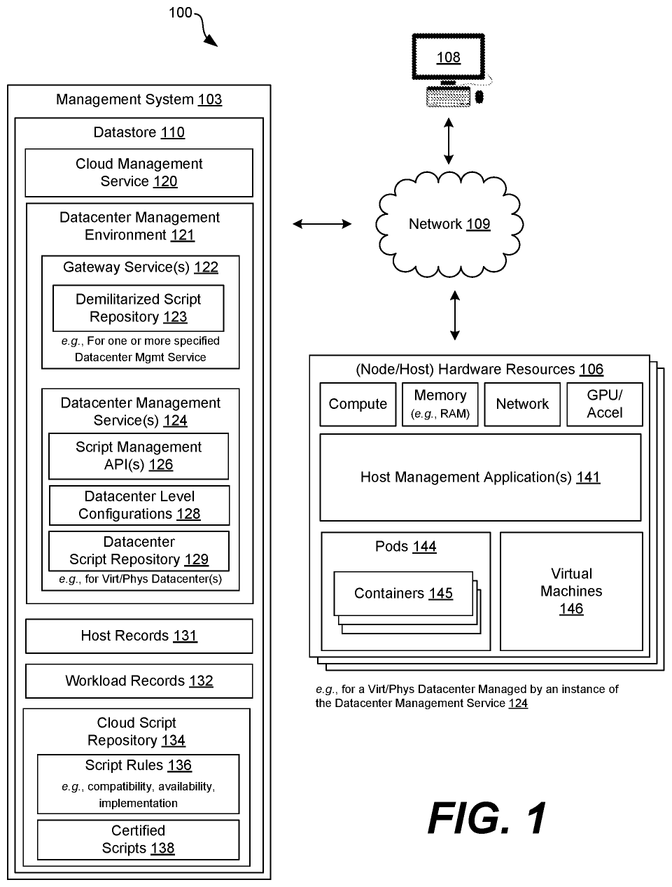

Turning to FIG. 1, an example of a networked environment 100 is shown. The networked environment 100 can include a management system 103, client device(s) 108, and hardware resources 106 in communication with one another over a network 109. The network 109 can include, for example, the Internet, intranets, extranets, wide area networks (WANs), local area networks (LANs), wired networks, wireless networks, other suitable networks, or any combination of two or more such networks.

The networks 109 can include satellite networks, cable networks, Ethernet networks, telephony networks, and other types of networks. In some examples, the components of the networked environment 100 can serve up virtual desktops to end users and, thus, can also be described as a virtual desktop infrastructure (VDI) environment. In other examples, the networked environment 100 can provide a public cloud computing environment, a private cloud computing environment, or a hybrid cloud computing environment. As such, the networked environment 100 can be referred to as a cloud computing environment in some examples.

The management system 103 can include a server computer or any other system providing computing capability. The management system 103 can provide access to functions for each of a number of different enterprises. While referred to in the singular, the management system 103 can include a plurality of computing devices that are arranged in one or more server banks, computer banks, or other arrangements. The management system 103 can include a grid computing resource or any other distributed computing arrangement. In some examples, the hosts that provide the hardware resources 106 can constitute the management system 103. The management system 103 can also include or be operated as one or more virtualized computer instances. For purposes of convenience, the management system 103 is referred to herein in the singular. Even though the management system 103 is referred to in the singular, it is understood that a plurality of management systems 103 can be employed in the various arrangements as described above. The components executed on the management system 103 can include a cloud management service 120 that can be used to oversee a datacenter management environment 121 that manages one or more private datacenters, which can include virtual distributed datacenters networked over a private WAN as well as on-premises hardware networked using a private LAN in various examples. The datacenter management environment 121 can include one or more gateway services 122 and one or more datacenter management services 124. A gateway service 122 can be provided for each datacenter management service 124, and each datacenter management service 124 can oversee a particular datacenter.

The cloud management service 120 can in some examples be the source from which all commands emanate for all datacenter management service 124. In some examples, the gateway service 122 or other sub-services can be instructed or delegated to perform actions and commands, which can be considered to emanate from the cloud management service 120, even if the gateway service 122 is executed separately from code of the cloud management service 120.

The cloud management service 120 can host the cloud script repository 134 in a secure and restricted location on the cloud. The cloud script repository 134 can contain signed or otherwise certified scripts 138 such as security, efficiency, feature-providing, and other action scripts which are to be executed on a datacenter management service 124. For maintainability, the certified scripts 138 can be grouped based on features into sub-directories in the cloud script repository 134, such as providing advisory messages or performing security scans. Alternatively, metadata can be provided that organizes the certified scripts 138 in a flat directory according various categories and script rules 136. The action organization directories or (script rules 136) can enforce or have the same controls as required under the cloud script repository 134. The action organization directories can share common binaries but can generally act independently of each other.

The cloud management service 120 can sync the cloud script repository 134 with a mirror repository such as the perimeter script repository 123 on the gateway that provides the gateway service 122 as a periodic, asynchronous, or on-demand process in various examples. The cloud management service 120 can also initiate commands for setting or assigning the perimeter script repository 123 location for each datacenter management service 124. This can specify a network address or location of the perimeter script repository 123 of the gateway service 122. The cloud management service 120 can also initiate commands for syncing the datacenter script repository 129 on the datacenter management service 124 with the perimeter script repository 123 of the gateway service 122, and executing certified scripts 138. The cloud management service 120 can instruct the gateway service 122 to perform these events. Response including results and data can be passed back to the cloud management service 120, where the next steps can be taken. In some examples, the cloud management service 120 can enable a remediation action in response to datacenter level configurations 128 or states detected for the datacenter management service 124. Remediation actions as needed can be performed by invoking an external mechanism or network service.

The gateway service 122 can in some examples include a cloud-based gateway service provided using a cloud layer device or set of devices. The datacenter management service 124 can be on a secure private network that is not exposed to the cloud script repository 134 which resides in a secured location of a public WAN or Internet. For the datacenter management service 124 to receive the certified scripts 138, the gateway service 122 can provide the perimeter script repository 123 to bridge the datacenter management service 124 to cloud script repository 134. The gateway service 122 is well situated to provide the functionality, since it access to the public Internet as well as the private network and hosts services of the datacenter level managed by the datacenter management service 124. The gateway service 122 can act as a proxy for sending commands and certified scripts 138 to the datacenter management service 124 from the cloud management service 120.

Setting up the perimeter script repository 123 on the gateway service 122 has the added advantage of efficiency gains as a single gateway service 122 and perimeter script repository 123 can be assigned to multiple datacenter management services 124. A gateway service 122 can service each datacenter management service 124 independently without having to connect back to the cloud management service 120 for each request, improving network efficiency.

In some examples, all actions that apply or update certified scripts 138 for a datacenter management service 124 can be triggered from the cloud by the cloud management service 120. Upon receiving the command, the agent on gateway service 122 can call the associated script management API 126 on the datacenter management service 124. In some examples, all actions that cause the gateway service 122 to invoke a script management API 126 can be triggered from the cloud by the cloud management service 120. Once actions are triggered, the datacenter management service 124 can be informed about the source location via API call.

The “source location” script management API 126 can set a repository location parameter of the specified datacenter management service 124 to a specified location of a perimeter script repository 123 on the gateway service 122. All future synchronization operations will synchronize the datacenter script repository 129 on datacenter management service 124 with the perimeter script repository 123 on the gateway service 122.

The cloud management service 120 can trigger a synchronization action by transmitting a command for the gateway service 122 to call a “sync” script management API 126 of the datacenter management service 124. The script management API 126 can pass to the datacenter management service 124 the script identifiers which need to be synced. In some examples, this requires renewed or initial authentication with the gateway service 122 to create a tunnel connection.

Once the tunnel is created, lifecycle management component of the datacenter management service 124 can download a manifest file, which contains details such as a unique script-id, script checksum, dependencies, and other helpful information. Once the manifest has been validated by a lifecycle management component of the datacenter management service 124, it will proceed with fetching the required files and dependencies as requested using the IDs specified in the script management API 126 call and the file details mentioned in the retrieved manifest of certified scripts 138. In various embodiments components other than the lifecycle management component can fulfill the same functionality.

The cloud management service 120 can trigger the gateway service 122 to perform a command that invokes a “run action”. The command can cause the gateway service 122 to invoke a “run action” script management API 126 call of the datacenter management service 124. The script management API 126 can pass to the datacenter management service 124 the script identifiers of certified scripts 138 which need to be executed. In some examples, this requires renewed or initial authentication with the gateway service 122 to create a tunnel connection. The run-action can be a long-running process, and can include a task API. Post execution of the certified scripts 138, the datacenter management service 124 can respond to the cloud management service 120 through the gateway service 122 with a result of the execution.

Execution of a run action script management API 126 call can include a compliance check type execution to that checks whether the datacenter management service 124 is in compliance with the certified scripts 138 and returns a result that indicates compliance or noncompliance status as well as a reason or set or configurations indicating compliance or noncompliance. Compliance check type execution does not affect the operation of the datacenter management service 124 or actually apply or enforce the certified scripts 138. Execution of a run action script management API 126 call with another parameter can cause the datacenter management service 124 to apply or enforce the certified scripts 138.

The gateway service 122 can maintain a perimeter script repository 123 that mirrors the cloud script repository 134 maintained at the cloud level. The cloud script repository 134 can include a repository of certified scripts 138 that are securely stored in the cloud layer in a private or restricted area of the management system 103 accessible by the cloud management service 120. The certified scripts 138 can be signed scripts and manifest, signed by a management entity. These certified scripts 138 can be securely provided to the datacenter management service 124 through a pipeline of components of the datacenter configuration management architecture.

The perimeter script repository 123 can be a mirror of the cloud script repository 134 that, unlike the cloud script repository 134, is in a demilitarized or perimeter layer accessible to the datacenter management service 124. For example, the perimeter script repository 123 can be accessed and maintained by the gateway service 122.

The datacenter management service 124 can maintain datacenter script repository 129. The datacenter script repository can include a datacenter-level mirror of the perimeter script repository 123, which accordingly also mirrors the cloud script repository 134. The datacenter management service 124 can be in a private layer within which the datacenter management service 124 resides and is executed. In some cases, a portion of the datacenter management service 124 that executes the certified scripts 138 is only permitted to execute scripts stored in the datacenter script repository 129, and only the components of the specified pipeline such as the datacenter management service 124 and/or the gateway service 122 is permitted to store certified scripts 138 to the datacenter script repository 129.

The datacenter management service 124 can include or be associated with a lifecycle management component that updates versions and applies intra-version updates of the datacenter management service 124 that do not change its version. This can include execution of certified scripts 138 received through the secure script delivery pipeline. The lifecycle management component can also service the script management APIs 126 of the datacenter management service 124.

On receiving the API call for setting a repository, the lifecycle management component can validate and store the repository location for future use. On receiving a sync API call, the lifecycle management component can initiate a download of all the specified certified scripts 138 and related dependencies from the predetermined perimeter script repository 123 and perform a specified or predetermined set validations before storing the certified scripts 138 in the local datacenter script repository 129. On receiving the run action API call, the lifecycle management component can trigger the specified certified scripts 138 with the parameters received and provide a result response in the predetermined format. All the certified scripts 138 can be executed with the root user to ensure they have maximum machine visibility.

The gateway service 122 can in some examples be considered a portion of the cloud management service 120. However, the gateway service 122 can operate in a demilitarized zone or perimeter network layer such that it has access to the private WAN or LAN of its datacenter and datacenter management service 124, as well as access to a public WAN such as the Internet and other networks 109. The gateway service 122 can alternatively be executed separately from the cloud management service 120.

In various embodiments, the management system 103 can include a plurality of devices, for example, the hardware resources 106. The devices can be installed in racks which can make up a server bank, aggregate computing system, or a computer bank in a data center or other like facility. In some examples, the management system 103 can include high-availability computing systems. A high-availability computing system is a group of computing devices that act as a single system to provide a continuous and constant uptime. The devices in the management system 103 can include any number of physical machines, virtual machines, pods, containers, virtual appliances, and software, such as operating systems, drivers, hypervisors, scripts, and applications.

In some examples, a management system 103 can include a computing environment that includes hundreds or even thousands of physical machines, as well as virtual machines 146 and other software implemented in devices stored in server racks, distributed geographically, and connected to one another through the network 109. It is understood that any virtual machine 146 or other virtual appliance can be implemented using at least one physical device, such as a server or other computing device.

For example, the management system 103 can utilize various hardware resources 106 in one or more virtual or physical datacenters to enable the operation of workloads including applications, microservices, pods 144, containers 145, and virtual machines 146. The hardware resources 106 can include physical computing hardware including, servers, datastores, memories, and other storage devices, switches, routers, and other network devices, graphics cards having one or more GPUs, central processing units (CPUs), power supplies, and other devices. In various examples, the servers can include requisite physical hardware and software to create and manage virtualization infrastructure or a cloud computing environment. In some examples, the computing resources can also include virtual computing resources, such as the virtual machines 146, the containers 145, and other virtualization software components.

The various components of the management system 103 can monitor usage data for the hardware resources 106. In some cases, the hardware resources 106 can include instructions to transmit this usage data to the datacenter management service 124 and the cloud management service 120. The usage data can include actual usage values and metrics for compute, memory, graphics, temporary storage, persistent storage, and other resources. Errors and other metrics can also be provided in the usage data. The usage data can be included in the host records 131.

The datastore 110 can include memory of the management system 103, mass storage resources of the management system 103, or any other storage resources on which data can be stored by the management system 103. The datastore 110 can include memory and datastores for the hardware resources 106. For instance, the datastore 110 can include one or more relational databases, such as structure query language (SQL) databases, non-SQL databases, or other relational or non-relational databases. The data stored in the datastore 110, for example, can be associated with the operation of the various services or functional entities described below. The datastore 110 can include a database or other memory that includes, for example, a cloud management service 120, host records 131, and workload records 132. Workload records 132 can include records for workloads deployed using one or more of the pods 144, containers 145, virtual machines 146, other virtual environments, and directly using various software executables.

The cloud management service 120 can include a set of one or more services provided at a cloud level by the overall management system 103. The cloud management service 120 can include an inventory service for the datacenter management services 124 corresponding to virtual and physical datacenters for the particular enterprise, as well as the hardware resources 106 such as nodes, hosts, pods 144, containers 145, and virtual machines 146 for each datacenter. The cloud management service 120 can also provide a configuration script service that has exclusive or shared access to the cloud script repository 134. In some examples, the configuration script service can include a security service that tracks and provides aggregated up to date information regarding security threats, as well as a general configuration service that tracks and provides aggregated up to date information regarding general configuration scripts for power, temperature, network usage, and other best practices. The cloud management service 120 can also provide an authentication service through which users associated with a particular enterprise can log in and access a console user interface that provides the ability to view and update configurations and other enterprise-specific data for each cloud level service. The cloud management service 120 can be provided as a SaaS offering or another access type.

The datacenter management service 124 can oversee the hardware resources 106 of a particular virtual and/or physical datacenter as well as its workloads. The datacenter management service 124, or the cloud management service 120, can create, organize, prioritize, distribute, balance, and destroy virtual machines 146, pods 144, containers 145, and other software components that include workloads that are assigned to utilize the hardware resources 106.

The datacenter management service 124 can track and manage hardware resource providers that can be referred to as hosts or nodes. Each host or node can provide to a particular subset of hardware resources 106. In some cases, each host can execute host management applications 141 or virtual machine deployment platform instructions associated with a virtual machine deployment platform. The host management applications 141 can include one or more software components that work in concert with the datacenter management service 124 to deploy workloads. This can include bare metal and hosted hypervisors in various examples, capable of deploying, removing, and otherwise managing virtual machines 146, pods 144, and containers 145.

The datacenter management service 124 can provide one or more script management application programming interfaces (APIs) 126 or other programmatic interfaces that can be programmatically invoked for remote compliance checks, delivery, and application of datacenter management configurations using scripts or other executable instructions. The datacenter level configurations 128 for the datacenter management service 124 can refer to the settings and configurations that govern the operation of the datacenter management service 124. This can include a listing of a set of certified scripts 138 applied to the datacenter management service 124. The certified scripts 138 can include a unique script identifier that uniquely identifies a particular script that applies one or more of the datacenter level configurations 128, such as security, efficiency, and other types of certified scripts 138.

The certified scripts 138 can refer to scripts or executable code that can be executed by a target datacenter management service 124 to perform an action, such as update a configuration or affect the environment and operation of the datacenter management service 124. The certified scripts 138 can be referred to as action-scripts as they contain “actions” to be performed on the target datacenter management service 124. The actions can be read-only commands or other types of commands, and can be executed in a non-intrusive manner such that the code of the target datacenter management service 124 is not affected. However, other examples can include actions that write or alter code of the target datacenter management service 124.

The certified scripts 138 can be tested and verified scripts that conform to one or more security standards or tests run by the cloud management service 120 or a trusted third party network service. The certified scripts 138 can be stored in association with script rules 136 that govern the compatibility, availability, importance, and implementation of the certified scripts 138 to the which datacenter management service 124. For example, the script rules 136 can indicate that a particular set of certified scripts 138 is compatible with a particular software version of the datacenter management service 124, the hardware that implements the datacenter management service 124, as well as the hardware and software components of the hardware resources 106 of the datacenter management service 124. The script rules 136 can also indicate whether the certified scripts 138 are available to the particular enterprise, for example, according to a service level agreement or another agreement. The script rules 136 can also provide an indication of importance such as a security level, efficiency rating, or another importance level for each certified script 138. The script rules 136 can also indicate whether the certified script 138 has been applied or executed on the datacenter management service 124, and a date and time of last execution or implementation.

Resource isolation or tenancy between enterprises, user groups, and users can be provided using resource pools. For example, each hardware resource 106 can be exclusively assigned to a single resource pool at a time. Affinity rules such as affinities and anti-affinities can be provided using virtual machine groups and host groups. For example, a virtual machine 146, pod 144, or container 145 can be logically associated with an affinity or anti-affinity with a host or another virtual machine 146, pod 144, or container 145. Resource requirements can be defined using a number of logical constructs such as compute, memory, network, GPU, accelerate (e.g., artificial intelligence or other specialized function processing), and other types of resources, as well as reservations, limits, and shares for allocation.

A host record 131 can represent information related to hardware resources 106 used to execute a workload such as an application, microservice, pod 144, container 145, or virtual machine 146. The host record 131 can include information such as the amount of memory installed on a host providing a subset of the hardware resources 106, the number and type of processors installed on the host, the number and type of GPUs installed on the host, the number and type of network connections installed on the host, and various other data. The host record 131 can also include information related to the workloads currently deployed on a host. This can include a record of specific applications, microservices, pods 144, containers 145, or virtual machines 146 that are identified using respective identifiers. The identifiers can include a common name associated with a particular application (or microservice, pod 144, container 145, or virtual machine 146), as well as universally unique identifiers that can identify a particular instance of the application or another component.

The host record 131 can include a record of the number of virtual machines 146, pods 144, and containers 145, as well as other workloads that are hosted using the hardware resources 106. As another example, the host record 131 can include a record of the amount and type of computer resources currently allocated to each of the virtual machines 146 deployed to the host. These records can include the number of processor cores, amount of memory, amount of storage, number of GPUs, and the number of network connections. Likewise, the host record 131 can include the amount of allocated computer resources consumed by each of the virtual machines 146. For example, the host record 131 can include an indication that one virtual machine 146 is consuming 75% of the memory allocated to it and is using 47% of the processor resources allocated to it, while another virtual machine 146 is consuming 15% of the memory allocated to it and is using 97% of the processor resources allocated to it.

A workload record 132 can represent information related to a workload, which can be embodied by one or more virtual machine 146, pod 144, container 145, or other virtual environment. For example, the information can include an identifier such as a universally unique identifier (UUID) or name for the virtual machine 146, pod 144, container 145, a version and type of operating system installed in the environment. A workload record 132 can also include the number and type of applications installed. In some implementations, the workload record 132 can also include a record of the amount and type of computer resources currently allocated to the virtual machine 146, pod 144, container 145, or other virtual environment associated with the workload. For example, the workload record 132 can include the number of processor cores, amount of memory, amount of storage, number of GPUs, and the number of network connections, GPUs, and accelerators. Likewise, the workload record 132 can include the amount of allocated computer resources currently consumed by the workload. For example, the workload record 132 can include an indication that a virtual machine 146, pod 144, container 145, or other virtual environment is consuming 75% of the memory allocated to it and is using 47% of the processor resources allocated to it. In some implementations, this information may be recorded in the workload record 132 on a historical basis, for example hourly, daily, monthly, and so on.

The datacenter management service 124 and the cloud management service 120 can oversee the operation of the networked environment 100 through management of the hardware resources 106 as well as the physical and virtual computing resources that make up the hardware resources 106. In some examples, an enterprise, organization, or other entity can operate the cloud management service 120 to oversee or manage the operation of devices in racks, such as servers, switches, datastores, CPUs, GPUs, power supplies, cooling systems, and other components. The datacenter management service 124 and the cloud management service 120 can organize and execute the workloads using virtual machines 146, pods 144, and containers 145, and other virtual environments. The cloud management service 120 can also provide persistent data for the workloads using hardware resources 106 without requiring an enterprise, developer, or administrator to configure and maintain a specific proprietary server.

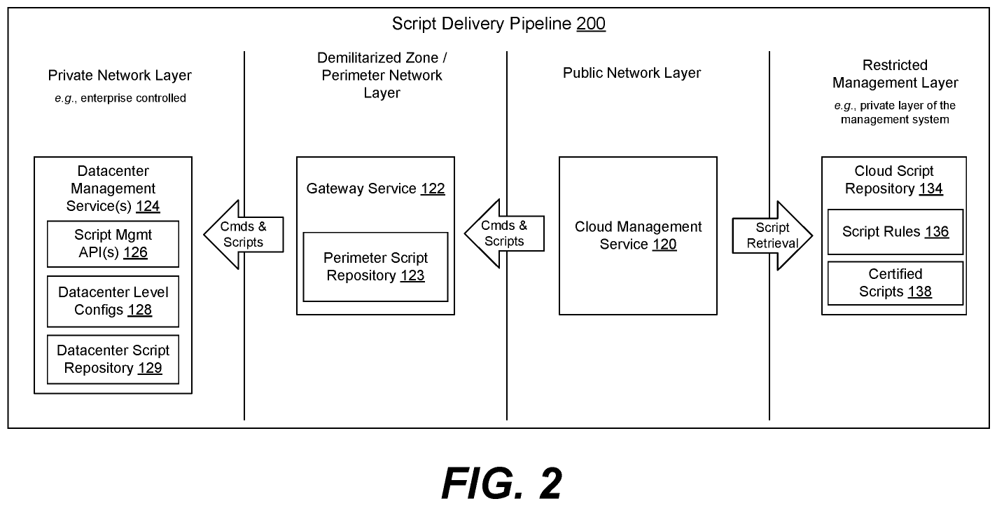

FIG. 2 is a drawing that illustrates an example of the operation of the components of the datacenter configuration management architecture. This drawing illustrates the security layers of a script delivery pipeline implemented using the datacenter configuration management architecture. In this examples, the configuration or script delivery pipeline 200 can include a private layer, a perimeter network layer or demilitarized zone, a public network layer and a restricted management layer. The script delivery pipeline 200 can provide a trusted communications pathway so that all communications associated with providing certified scripts 138 from the cloud script repository 134 to the datacenter script repository 129 are trusted, secured communications. In some examples, this can include secure and encrypted end-to-end communications such as tunnel communications or other types of secure communications at each link in the script delivery pipeline 200.

The private network layer can refer to an enterprise-controlled, trusted internal networking layer that includes the datacenter management service 124. The components of the private network layer can be behind an enterprise-controlled firewall. The private network layer can include a private LAN or private WAN. The private network layer can include components that are located in one location or widely distributed over many locations. The private network layer can include a datacenter management service 124 and all hardware resources 106 such as nodes and hosts of the datacenter that is managed using that datacenter management service 124. In this example, the datacenter management service 124 can maintain or have access to a datacenter script repository 129 within the private network layer. The datacenter management service 124 can also have script management APIs 126 and the datacenter level configurations 128.

A demilitarized zone can refer to a networking layer that can be viewed separately from the private network layer and the public network layer, but having access to both the public network and the private network. The gateway service 122 can in some examples be executed using cloud-based components of the management system 103. For example, the gateway service 122 can be part of the cloud management service 120.

The gateway service 122 of the demilitarized zone can have limited connectivity to specific components or endpoints in the private network layer, and limited connectivity to specific components or endpoints in the public network layer or Internet. The gateway service 122 can expose external-facing enterprises services to the public network layer. This can include any number of services, but in this context the gateway service 122 can mediate script and datacenter configuration management for its assigned datacenter management service 124. The gateway service 122 can include the perimeter script repository 123. The perimeter script repository 123 can mirror the cloud script repository 134. The cloud script repository 134 can be located in the restricted management layer and inaccessible to the gateway service 122 and the demilitarized zone components as well as the enterprise private network layer, but can be accessible to the cloud management service 120. In alternative examples, the cloud script repository 134 can be accessible to the gateway service 122, and the gateway service 122 can synchronize the perimeter script repository 123 using the cloud script repository 134 periodically, on a schedule, and in response to commands from the cloud management service 120.

The public network layer can include a public LAN or public WAN such as the Internet. The cloud management service 120 can include one or more endpoints that are available over the Internet, for example, enabling access to programmatic and website based communications. This can include endpoints open to the gateway service 122 and client devices 108 that are authenticated using certificates, tokens, passwords, and other authentication credentials.

The restricted management layer can include a management-service-controlled private internal networking layer controlled by the management system 103 and cloud management service 120. The restricted management layer can be behind a management-controlled firewall. The restricted management layer can include the cloud script repository 134, which can include an administratively tested, verified, and curated set of certified scripts 138. Since the certified scripts 138 are administratively tested, verified, and curated, an enterprise can be assured of the safety and efficacy of the certified scripts 138.

The script delivery pipeline 200 can enable secure and programmatic delivery of the certified scripts 138 to the datacenter management services 124. For example, the cloud management service 120 can retrieve certified scripts 138 and script rules 136 from the cloud script repository 134 in the restricted management layer. In some examples, the gateway service 122 can communicate with an endpoint of the cloud management service 120 to request the retrieval of certified scripts 138 and script rules 136 from the cloud script repository 134. The gateway service 122 can provide the certified scripts 138 and the script rules 136 to the gateway service 122. In this way, the perimeter script repository 123 can be referred to as a gateway, demilitarized, or perimeter level mirror repository that mirrors the cloud script repository 134.

The gateway service 122 can invoke a script management API 126 of the datacenter management service 124 to synchronize the datacenter script repository 129 with the perimeter script repository 123. This can deliver the certified scripts 138 and the script rules 136 to the datacenter script repository 129. The perimeter script repository 123 can be referred to as a private or datacenter level mirror repository that mirrors the perimeter script repository 123 and the cloud script repository 134.

The gateway service 122 can invoke a script management API 126 of the datacenter management service 124 to update a configuration of the datacenter management service 124. For example, the gateway service 122 can invoke a script management API 126 of the datacenter management service 124 to run a certified script 138 once, periodically, or on a schedule according to the script rules 136. In some examples, the gateway service 122 invokes the script management API 126 once, periodically, or on a schedule according to the script rules 136, and in other cases a portion of the script rules 136 are provided when the script management API 126 is invoked, causing the datacenter management service 124 to run a certified script 138 once, periodically, or on a schedule.

In some cases, a single script management API 126 performs all of the functions or functionalities discussed by providing certain parameters that indicate which function to perform. In other examples, a different script management API 126 can be provided for each functionality. For example, the same or a different script management API 126 can be provided to set a location of its assigned perimeter script repository 123, to sync the datacenter script repository 129 with the perimeter script repository 123, to run or schedule a compliance check of the current configurations and scripts of the datacenter management service 124, to enable or run scripts, and to disable or revert scripts. The location of the perimeter script repository 123 can refer to a network address such as an Internet Protocol address, a hypertext transport protocol address, or another type of networking address of the gateway service 122 that maintains the perimeter script repository 123.

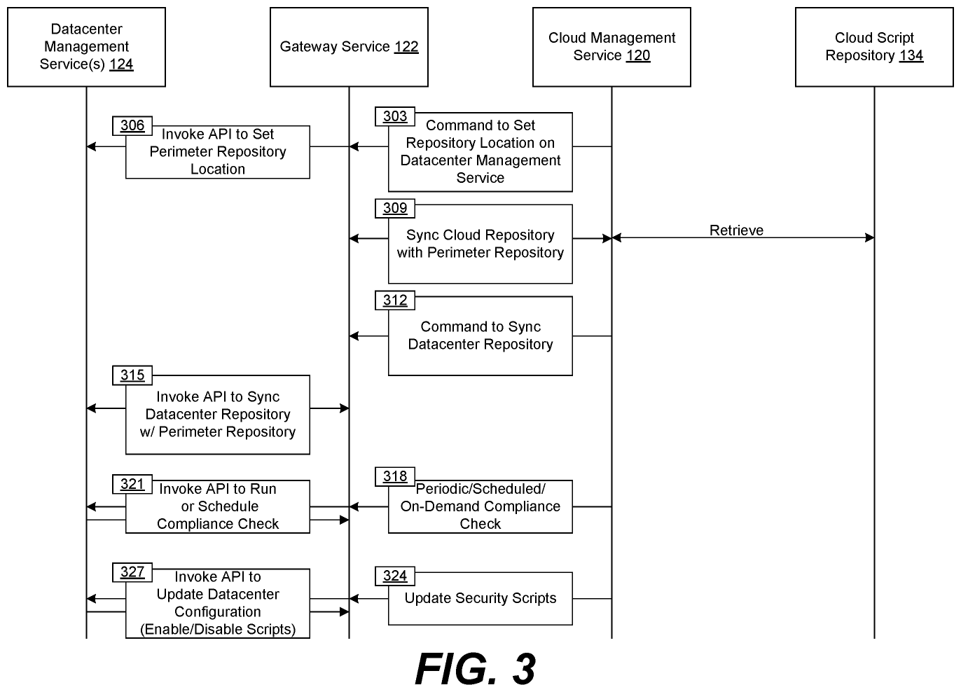

FIG. 3 is a sequence diagram illustrating functionalities implemented by components of the datacenter configuration management architecture. The sequence diagram outlines how the components of the networked environment 100 work in concert to provide the configuration or script delivery pipeline 200 and the datacenter configuration management architecture. While certain components can be described as performing a particular step, each of the steps can also include actions performed by other components.

In step 303, the cloud management service 120 can transmit a repository location command to the gateway service 122. The gateway service 122 can receive the repository location command. The repository location command can instruct the gateway service 122 to invoke a script management API 126 to set a repository location for the datacenter management service 124.

In step 306, the gateway service 122 can invoke the repository location script management API 126 using a call that specifies the location of the perimeter script repository of that gateway service 122. The gateway service 122 can identify a predetermined or command-specified network address or location. The network location can be a location of the perimeter script repository 123 of that gateway service 122. A “source location” script management API 126 of the datacenter management service 124 can set a repository location parameter of the specified datacenter management service 124 to the specified location of the perimeter script repository 123 of the gateway service 122.

In step 309, the cloud management service 120 can synchronize the perimeter script repository 123 using information in the cloud script repository 134. The cloud management service 120 can retrieve the certified scripts 138 from the cloud script repository 134 and transmit the certified scripts 138 to the gateway service 122. The gateway service 122 can store the certified scripts 138 in the perimeter script repository 123. In some examples, the script rules 126 and a manifest can also be retrieved (or generated) and provided to the gateway service 122 along with the certified scripts 138.

In step 312, the cloud management service 120 can transmit a datacenter script synchronization command to the gateway service 122. The datacenter script synchronization command can be transmitted periodically, on a schedule, or on demand. The cloud management service 120 can include a console user interface through which a user of a client device 108 can trigger the datacenter script synchronization to be transmitted. The command can cause the gateway service 122 to synchronize the datacenter script repository 129 using information in the perimeter script repository 123. The gateway service 122 can receive the datacenter script synchronization command and can invoke a synchronization script management API 126 using a parameter that specifies a manifest or list of certified scripts 138 that should be retrieved.

The datacenter management service 124 can identify the location of the perimeter script repository 123 based on the previously specified parameter. The synchronization script management API 126 can cause the datacenter management service 124, for example, its lifecycle management component, to download the specified or included manifest file, which contains details such as a set of certified scripts 138 specified using their unique identifiers. The manifest can also include a script checksum, dependencies, and other information. Once the manifest has been validated by the lifecycle management component, it will proceed with fetching the required files and dependencies as requested using the script identifiers specified in the script management API 126 call and/or the manifest. The datacenter management service 124 can use the script checksum to verify that each of the certified scripts 138 unaltered, uncorrupted, and otherwise valid. A synchronization status or result of the synchronization action can be transmitted back to the gateway service 122, which can relay this back to the cloud management service 120. The synchronization status can indicate whether the overall action is completed, as well as which certified scripts 138 were successfully or unsuccessfully synchronized.

In step 318, the cloud management service 120 can transmit a compliance check command to the gateway service 122. The compliance check command can be transmitted periodically, on a schedule, or on demand. The cloud management service 120 can include a console user interface through which a user of a client device 108 can trigger the compliance check command to be transmitted.

In step 321, the gateway service 122 can receive the compliance check command and invoke a corresponding compliance check script management API 126 of the datacenter management service 124. The compliance check script management API 126 can run a compliance check or schedule a compliance check to run at a specified date, as well as with a specified frequency or schedule. The compliance check script management API 126 can cause the datacenter management service 124 to execute the certified script 138 in a manner that checks compliance with the certified script 138 relative to the current datacenter level configurations 128, rather than changing or updating them to affect the operation of the datacenter management service 124.

A compliance check status or result of the compliance check action can be transmitted back to the gateway service 122, which can relay this back to the cloud management service 120. The compliance check status can indicate whether the overall action is completed, as well as which certified scripts 138 were in compliance or out of compliance based on the datacenter level configurations 128.

In step 324, the cloud management service 120 can transmit a run script command to the gateway service 122. The run script command can be transmitted periodically, on a schedule, or on demand. The cloud management service 120 can include a console user interface through which a user of a client device 108 can trigger the run script command to be transmitted.

In step 327, the gateway service 122 can receive the update script command and invoke a corresponding “update script” script management API 126 of the datacenter management service 124. The “update script” API can cause the datacenter management service 124 to execute the certified script 138, or schedule execution of a certified script 138 at a specified date, as well as with a specified frequency or schedule. Unlike the compliance check execution, the “update script” API causes the datacenter management service 124 to change its datacenter level configurations 128. An update script status or result of the update script or script execution action can be transmitted back to the gateway service 122, which can relay this back to the cloud management service 120. The update script status can indicate whether the overall action is completed, as well as which certified scripts 138 were updated or failed to update.

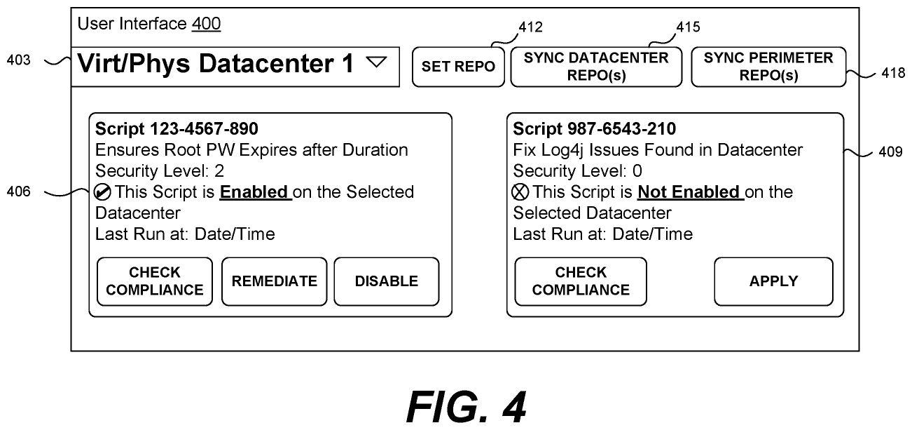

FIG. 4 is a drawing that illustrates an example of a user interface 400 generated by a management console of the cloud management service 120. The user interface 400 includes a datacenter selector 403, a script card or user interface element 406, and a script card or user interface element 409. The user interface 400 also includes a set repository user interface element 412, a sync datacenter repository user interface element 415, and a synch perimeter repository user interface element 418.

The user interface element 406 and the user interface element 409 correspond to the certified scripts 138 that are available for the currently selected and identified datacenter or datacenter management service 124. In some examples, the datacenter or datacenter management service 124 is identifies using a unique datacenter identifier or a friendly name.

The datacenter selector 403 can provide an indication of a currently selected datacenter or datacenter management service 124. User manipulation or interaction with the datacenter selector 403 can cause a list of datacenters or datacenter management services 124 to be shown. The list can include all datacenters or datacenter management services 124 associated with an enterprise. The enterprise can be identified based on credentials or an account of a user of a client device 108 that is logged into the management console. If another datacenter or datacenter management service 124 is selected, the certified scripts 138 that are available for that datacenter can be shown.

The user interface element 406 can provide the most current compliance status information as well as other information for the identified certified script 138. The user interface element 406 can show a unique identifier of the certified script 138. The user interface element 406 can show a friendly textual description that identifies a purpose of the certified script 138. The user interface element 406 can show a security level or other importance level of the certified script 138. The user interface element 406 can show an indication of whether the certified script 138 is enabled or disabled on the identifier datacenter. The user interface element 406 can show a most recent time and date that the certified script 138 has been executed.

The user interface element 406 is for a certified script 138 that is enabled, and the user interface element 406 can include a number of action user interface elements identified based on this status. The action user interface elements of the user interface element 406 can include a compliance check button, a remediate button, and a disable button. The compliance check button can trigger a compliance check of the datacenter in association with the certified script 138 identified in the user interface element 406. The remediate button can transmit a command to remediate an issue identified in a compliance check. The remediate button can transmit a notification to an administrative user or a third party service to manually remediate the identified issue, or a command that programmatically remediates the identified issue using the gateway service 122 or a third party service. The disable button can disable the certified script 138 identified in the user interface element 406, which is currently enabled according to the user interface element 406.

The user interface element 409 can provide the most current compliance status information as well as other information for the identified certified script 138. The user interface element 409 can show a unique identifier of the certified script 138. The user interface element 409 can show a friendly textual description that identifies a purpose of the certified script 138. The user interface element 409 can show a security level or other importance level of the certified script 138. The user interface element 409 can show an indication of whether the certified script 138 is enabled or disabled on the identifier datacenter. The user interface element 409 can show a most recent time and date that the certified script 138 has been executed.

The user interface element 409 is for a certified script 138 that is disabled or not enabled, and the user interface element 409 can include a number of action user interface elements identified based on this status. The action user interface elements of the user interface element 406 can include a compliance check button, and an apply button. The compliance check button can trigger a compliance check of the datacenter in association with the certified script 138 identified in the user interface element 409. The enable button can enable or execute the certified script 138 identified in the user interface element 406, which is currently disabled according to the user interface element 409.

The set repository user interface element 412 can set a repository location parameter for the identified datacenter. In various examples, selection of this element can automatically assign a particular gateway service 122 or perimeter script repository 123 to the identified datacenter, or the cloud management service 120 can update the user interface 400 to show a user interface element through which a perimeter script repository 123 can be selected, entered, updated, changed, or otherwise identified.

The sync datacenter repository user interface element 415 can synchronize one or more datacenter script repository 129, for example, for all datacenters or for the identified datacenter, to match the associated perimeter script repository 123. The synch perimeter repository user interface element 418 can synchronize one or more perimeter script repository 123 to match the cloud script repository 134.

Stored in the memory device are both data and several components that are executable by the processor. Also stored in the memory can be a datastore 110 and other data. A number of software components are stored in the memory and executable by a processor. In this respect, the term “executable” means a program file that is in a form that can ultimately be run by the processor. Examples of executable programs can be, for example, a compiled program that can be translated into machine code in a format that can be loaded into a random access portion of one or more of the memory devices and run by the processor, code that can be expressed in a format such as object code that is capable of being loaded into a random access portion of the one or more memory devices and executed by the processor, or code that can be interpreted by another executable program to generate instructions in a random access portion of the memory devices to be executed by the processor. An executable program can be stored in any portion or component of the memory devices including, for example, random access memory (RAM), read-only memory (ROM), hard drive, solid-state drive, USB flash drive, memory card, optical disc such as compact disc (CD) or digital versatile disc (DVD), floppy disk, magnetic tape, or other memory components.

Memory can include both volatile and nonvolatile memory and data storage components. In addition, a processor can represent multiple processors and/or multiple processor cores, and the one or more memory devices can represent multiple memories that operate in parallel processing circuits, respectively. Memory devices can also represent a combination of various types of storage devices, such as RAM, mass storage devices, flash memory, or hard disk storage. In such a case, a local interface can be an appropriate network that facilitates communication between any two of the multiple processors or between any processor and any of the memory devices. The local interface can include additional systems designed to coordinate this communication, including, for example, performing load balancing. The processor can be of electrical or of some other available construction.

Client devices 108 can be used to access user interfaces generated to configure or otherwise interact with the cloud management service 120. These client devices 108 can include a display upon which a user interface can be rendered. In some examples, the user interface can be generated using user interface data provided by the management system 103. The client device 108 can also include one or more input/output devices that can include, for example, a capacitive touchscreen or other type of touch input device, fingerprint reader, or keyboard.

Although the various programs and applications of the systems described herein can be embodied in software or code executed by general-purpose hardware as discussed above, as an alternative, the same can also be embodied in dedicated hardware or a combination of software/general purpose hardware and dedicated hardware. If embodied in dedicated hardware, each can be implemented as a circuit or state machine that employs any one of or a combination of a number of technologies. These technologies can include discrete logic circuits having logic gates for implementing various logic functions upon an application of one or more data signals, application specific integrated circuits (ASICs) having appropriate logic gates, field-programmable gate arrays (FPGAs), or other components.

Sequence diagrams and flowcharts can show an example of the functionality and operation of an implementation of portions of components described herein. If embodied in software, each block can represent a module, segment, or portion of code that can include program instructions to implement the specified logical function(s). The program instructions can be embodied in the form of source code that can include human-readable statements written in a programming language or machine code that can include numerical instructions recognizable by a suitable execution system such as a processor in a computer system or other system. The machine code can be converted from the source code. If embodied in hardware, each block can represent a circuit or a number of interconnected circuits to implement the specified logical function(s).

Although the sequence diagrams and flowcharts can show a specific order of execution, it is understood that the order of execution can differ from that which is depicted. For example, the order of execution of two or more blocks can be scrambled relative to the order shown. In addition, two or more blocks shown in succession can be executed concurrently or with partial concurrence. Further, in some examples, one or more of the blocks shown in the drawings can be skipped or omitted.

Also, any logic or application described herein that includes software or code can be embodied in any non-transitory computer-readable medium for use by or in connection with an instruction execution system such as, for example, a processor in a computer system or other system. In this sense, the logic can include, for example, statements including program code, instructions, and declarations that can be fetched from the computer-readable medium and executed by the instruction execution system. In the context of the present disclosure, a “computer-readable medium” can be any medium that can contain, store, or maintain the logic or application described herein for use by or in connection with the instruction execution system.

The computer-readable medium can include any one of many physical media, such as magnetic, optical, or semiconductor media. More specific examples of a suitable computer-readable medium include solid-state drives or flash memory. Further, any logic or application described herein can be implemented and structured in a variety of ways. For example, one or more applications can be implemented as modules or components of a single application. Further, one or more applications described herein can be executed in shared or separate computing devices or a combination thereof. For example, a plurality of the applications described herein can execute in the same computing device, or in multiple computing devices.

It is emphasized that the above-described examples of the present disclosure are merely possible examples of implementations set forth for a clear understanding of the principles of the disclosure. Many variations and modifications can be made to the above-described embodiments without departing substantially from the spirit and principles of the disclosure. While certain aspects can be discussed with respect to a particular figure, the aspects discussed with respect a particular figure can also be performed in the context of other figures as can be understood. All such modifications and variations are intended to be included herein within the scope of this disclosure.

Therefore, the following is claimed:

1. A non-transitory computer-readable medium, comprising executable instructions, wherein the instructions, when executed by at least one processor, cause at least one computing device to at least:
invoke, by a gateway service, a set repository function provided using at least one programmatic interface of a datacenter management service that manages a datacenter, wherein the set repository function causes the datacenter management service to use a perimeter layer script repository of the gateway service for synchronization;
invoke, by the gateway service, a synchronize datacenter repository function provided using the at least one programmatic interface of the datacenter management service, wherein the synchronize datacenter repository function causes the datacenter management service to synchronize a datacenter layer script repository to store a script identified and retrieved from the perimeter layer script repository specified using the set repository function;
invoke, by the gateway service, at least one of a compliance check function and a run script function provided using the at least one programmatic interface of the datacenter management service, wherein the at least one of the compliance check function and the run script function causes the datacenter management service to execute the script from the datacenter layer script repository.

2. The non-transitory computer-readable medium of claim 1, wherein the compliance check function executes the script to perform a compliance check that identifies a compliance status based on a comparison of a script-specified datacenter configuration specified in the script to an actual datacenter configuration of the datacenter.

3. The non-transitory computer-readable medium of claim 2, wherein the compliance check function does not change the actual datacenter configuration.

4. The non-transitory computer-readable medium of claim 1, wherein the run script function executes the script to update a datacenter configuration of the datacenter.

5. The non-transitory computer-readable medium of claim 1, wherein the instructions, when executed by the at least one processor, cause the at least one computing device to at least:
synchronize the perimeter repository of the gateway service to store the script identified and retrieved from a cloud layer script repository maintained in a restricted area of a cloud management service.

6. The non-transitory computer-readable medium of claim 1, wherein the gateway service provides a perimeter networking layer and mediates communication from a private networking layer of the datacenter to a public networking layer.

7. The non-transitory computer-readable medium of claim 1, wherein the script is a certified script that is provided and certified by a cloud management service.

8. A method performed by instructions executed by at least one processor of at least one computing device, the instructions comprising:
invoking, by a gateway service, a set repository function provided using at least one programmatic interface of a datacenter management service that manages a datacenter, wherein the set repository function causes the datacenter management service to use a perimeter layer script repository of the gateway service for synchronization;
invoking, by the gateway service, a synchronize datacenter repository function provided using the at least one programmatic interface of the datacenter management service, wherein the synchronize datacenter repository function causes the datacenter management service to synchronize a datacenter layer script repository to store a script identified and retrieved from the perimeter layer script repository specified using the set repository function;
invoking, by the gateway service, at least one of a compliance check function and a run script function provided using the at least one programmatic interface of the datacenter management service, wherein the at least one of the compliance check function and the run script function causes the datacenter management service to execute the script from the datacenter layer script repository.

9. The method of claim 8, wherein the compliance check function executes the script to perform a compliance check that identifies a compliance status based on a comparison of a script-specified datacenter configuration specified in the script to an actual datacenter configuration of the datacenter.

10. The method of claim 9, wherein the compliance check function does not change the actual datacenter configuration.

11. The method of claim 8, wherein the run script function executes the script to update a datacenter configuration of the datacenter.

12. The method of claim 8, further comprising
synchronizing the perimeter repository of the gateway service to store the script identified and retrieved from a cloud layer script repository maintained in a restricted area of a cloud management service.

13. The method of claim 8, wherein the gateway service provides a perimeter networking layer and mediates communication from a private networking layer of the datacenter to a public networking layer.

14. The method of claim 13, wherein the script is a certified script that is provided and certified by a cloud management service.

15. A system comprising:
at least one computing device comprising at least one processor;
at least one memory comprising executable instructions, wherein the instructions, when executed by the at least one processor, cause the at least one computing device to at least:
invoke, by a gateway service, a set repository function provided using at least one programmatic interface of a datacenter management service that manages a datacenter, wherein the set repository function causes the datacenter management service to use a perimeter layer script repository of the gateway service for synchronization;
invoke, by the gateway service, a synchronize datacenter repository function provided using the at least one programmatic interface of the datacenter management service, wherein the synchronize datacenter repository function causes the datacenter management service to synchronize a datacenter layer script repository to store a script identified and retrieved from the perimeter layer script repository specified using the set repository function;
invoke, by the gateway service, at least one of a compliance check function and a run script function provided using the at least one programmatic interface of the datacenter management service, wherein the at least one of the compliance check function and the run script function causes the datacenter management service to execute the script from the datacenter layer script repository.

16. The system of claim 15, wherein the compliance check function executes the script to perform a compliance check that identifies a compliance status based on a comparison of a script-specified datacenter configuration specified in the script to an actual datacenter configuration of the datacenter.

17. The system of claim 16, wherein the compliance check function does not change the actual datacenter configuration.

18. The system of claim 15, wherein the run script function executes the script to update a datacenter configuration of the datacenter.

19. The system of claim 15, wherein the instructions, when executed by the at least one processor, cause the at least one computing device to at least:
synchronize the perimeter repository of the gateway service to store the script identified and retrieved from a cloud layer script repository maintained in a restricted area of a cloud management service.

20. The system of claim 15, wherein the gateway service provides a perimeter networking layer and mediates communication from a private networking layer of the datacenter to a public networking layer.
